(19) United States
(12) Patent Application Publication
(10) Pub. No.: US 2015/0138638 A1
(43) Pub. Date: May 21, 2015

(54) OPTICAL ELEMENT

(71) Applicant: ASAHI GLASS COMPANY, LIMITED, Chiyoda-ku (JP)

(72) Inventors: Takahiro Mashimo, Chiyoda-ku (JP); Susumu Suzuki, Chiyoda-ku (JP); Mitsuo Osawa, Chiyoda-ku (JP); Koji Miyasaka, Chiyoda-ku (JP); Takaaki Murakami, Chiyoda-ku (JP)

(73) Assignee: ASAHI GLASS COMPANY, LIMITED, Chiyoda-ku (JP)

(21) Appl. No.: 14/562,019

(22) Filed: Dec. 5, 2014

Related U.S. Application Data
(63) Continuation of application No. PCT/JP2013/064412, filed on May 23, 2013.

(30) Foreign Application Priority Data
Jun. 8, 2012 (JP) 2012-130711

(51) Int. Cl. G02B 1/10; G02B 27/00; G02B 1/02; G02B 1/11

(52) U.S. Cl. CPC G02B 1/105; G02B 1/115; G02B 27/0006; G02B 1/02
USPC 359/513; 359/580; 359/586; 359/581

(57) ABSTRACT

An optical element includes an optical member made of a material that transmits light; a high refractive index layer and a low refractive index layer that are stacked on a front surface of the optical member; and a surface protection layer that is formed on an upper most layer among the high refractive index layer and the low refractive index layer, the surface protection layer being made of a material including one of a mixed oxide of Si and Sn, a mixed oxide of Si and Zr, and a mixed oxide of Si and Al, and the refraction index of the surface protection layer being less than or equal to the refraction index of the high refractive index layer and greater than or equal to the refraction index of the low refractive index layer.

### CROSS-REFERENCE TO RELATED APPLICATION

This application is a continuation application filed under 35 U.S.C. 111(a) claiming the benefit under 35 U.S.C. 120 and 365(c) of PCT International Application No. PCT/JP2013/064412 filed on May 23, 2013, which is based upon and claims the benefit of priority of Japanese Priority Application No. 2012-130711 filed on Jun. 8, 2012, and the entire contents of which are hereby incorporated by reference.

### BACKGROUND OF THE INVENTION

1. Field of the Invention

The present invention relates to an optical element.

2. Description of the Related Art

An optical element such as a lens, a cover glass or the like that is used in an optical device is made of a transparent material such as a glass or the like that transmits light. However, as such a material has a predetermined refraction index, about 8% of the light is reflected at a front surface or a back surface. Thus, due to the reflection at the front surface or the back surface of the optical element, transmittance of the light is lowered. In order to suppress such reflection of the light at the front surface or the back surface of the optical element, generally, an antireflection film is provided at the front surface or the back surface of the optical element such as the lens, the cover glass or the like. By providing the antireflection film as such, the transmittance of the optical element such as the lens, the cover glass or the like can be increased.

Here, among electronic devices such as mobile phones or the like, some of them have a camera function such as a digital camera or the like. Then, the optical element such as the lens, the cover glass or the like is used at a portion where the camera function is provided. However, as the mobile phone or the like is carried by a user, if a front surface of the optical element such as the lens, the cover glass or the like is exposed, the front surface of the optical element contacts various objects and is rubbed. If the front surface of the optical element such as the lens, the cover glass or the like is rubbed in such a manner, if the antireflection film is formed at the front surface of the optical element, as the antireflection film is easily damaged, the antireflection film is damaged by being rubbed and optical characteristics of the optical element is lowered.

Here, generally, the antireflection film has a structure in which low refraction index materials and high refraction index materials made of a dielectric or the like are stacked and an uppermost layer, which becomes the outermost front surface, is made of the low refraction index material. In the antireflection film configured as such, if magnesium fluoride is used as the low refraction index material, as fluoride such as magnesium fluoride or the like is damaged extremely easily, characteristics of the optical element is lowered by being rubbed.

Further, as another method to form the antireflection film with a higher strength, without using fluoride such as magnesium fluoride or the like, oxide is used as the low refractive index layer or the like. Specifically, for example, there is a method in which SiO₂ is used as the low refraction index material and Ta₂O₅ is used as the high refraction index material, and they are alternately stacked with each other. However, although not as soft as the magnesium fluoride, SiO₂ is also soft. Thus, SiO₂ is damaged by being rubbed and characteristics of the optical element are lowered.

FIG. 1 illustrates an optical element 900 in which an antireflection film made of oxide is formed. Specifically, the antireflection film made of oxide as described above in which two high refractive index layers 921 each made of Ta₂O₅ and two low refractive index layers 922 each made of SiO₂ are alternately stacked is formed on an optical member 910 such as a lens, a substrate or the like made of a glass or the like. In other words, a high refractive index layer 921a, a low refractive index layer 922a, a high refractive index layer 921b and a low refractive index layer 922b are stacked on the optical member 910 in this order.

### PATENT DOCUMENT

[Patent Document 1] Japanese Laid-open Patent Publication No. H07-81977

### SUMMARY OF THE INVENTION

The present invention is made in light of the above problems, and provides an optical element in which an antireflection film is formed that is hardly damaged even when being rubbed and has high scratch resistance.

According to an embodiment, there is provided an optical element including an optical member made of a material that transmits light; a high refractive index layer and a low refractive index layer that are stacked on a front surface of the optical member; and a surface protection layer that is formed on an upper most layer among the high refractive index layer and the low refractive index layer, the surface protection layer being made of a mixed oxide of Si and Sn, and the refraction index of the surface protection layer being less than or equal to the refraction index of the high refractive index layer and greater than or equal to the refraction index of the low refractive index layer.

Further, according to another embodiment, there is provided an optical element including an optical member made of a material that transmits light; a high refractive index layer and a low refractive index layer that are stacked on a front surface of the optical member; and a surface protection layer that is formed on an upper most layer among the high refractive index layer and the low refractive index layer, the surface protection layer being made of a mixed oxide of Si and Zr, and the refraction index of the surface protection layer being less than or equal to the refraction index of the high refractive index layer and greater than or equal to the refraction index of the low refractive index layer.

Further, according to another embodiment, there is provided an optical element including an optical member made of a material that transmits light; a high refractive index layer and a low refractive index layer that are stacked on a front surface of the optical member; and a surface protection layer that is formed on an upper most layer among the high refractive index layer and the low refractive index layer, the surface protection layer being made of a mixed oxide of Si and Al, and the refraction index of the surface protection layer being less than or equal to the refraction index of the high refractive index layer and greater than or equal to the refraction index of the low refractive index layer.

Further, according to another embodiment, there is provided an optical element including an optical member made of a material that transmits light; a high refractive index layer and a low refractive index layer that are stacked on a front surface of the optical member; and an antifouling coating layer formed on an uppermost layer among the high refractive index layer and the low refractive index layer.

Note that also arbitrary combinations of the above-described elements, and any changes of expressions in the present invention, made among methods, devices, systems and so forth, are valid as embodiments of the present invention.

According to the embodiment, an optical element in which an antireflection film is formed that is hardly damaged even when being rubbed and has high scratch resistance can be provided.

### BRIEF DESCRIPTION OF THE DRAWINGS

Other objects, features and advantages of the present invention will become more apparent from the following detailed description when read in conjunction with the accompanying drawings.

FIG. 1 is a view illustrating a structure of a conventional optical element;

FIG. 2 is a view illustrating a structure of an optical element 1 of the embodiment;

FIG. 3 is a view illustrating a structure of an optical element 2 of the embodiment;

FIG. 4 is a view illustrating a structure of an optical element 3 of the embodiment;

FIG. 5 is a correlation diagram of the wavelength and the reflectance of a conventional optical element and optical elements 1 and 2;

FIG. 6 is a correlation diagram of the wavelength and the reflectance of an optical element 3;

FIG. 7 is a view (1) illustrating a relationship between the refraction index and the thickness of a surface protection layer of the optical element of the embodiment;

FIG. 8 is a view (2) illustrating a relationship between the refraction index and the thickness of the surface protection layer of the optical element of the embodiment;

FIG. 9 is a view illustrating a structure of an optical element 4 of the embodiment;

FIG. 10 is a view for explaining a spectral transmittance curve of an ultraviolet and infrared ray reflection film;

FIG. 11 is a view illustrating a structure of an optical element 5 of the embodiment;

FIG. 12 is a view illustrating a structure of an optical element 6 of the embodiment;

FIG. 13 is a view illustrating a structure of the optical element of example 1;

FIG. 14 is a view illustrating a structure of the optical element of example 2;

FIG. 15 is a view illustrating an example of reflectance characteristics designed when manufacturing the optical element of example 2;

FIG. 16 is a view illustrating a structure of the optical element of example 3;

FIG. 17 is a view illustrating an example of reflectance characteristics designed when manufacturing the optical element of example 3;

FIG. 18 is a view illustrating a structure of the optical element of example 4;

FIG. 19 is a view illustrating a structure of the optical element of example 7;

FIG. 20 is a view illustrating a structure of the optical element of example 8;

FIG. 21 is a view illustrating a structure of the optical element of example 9;

FIG. 22 is a view illustrating a structure of the optical element of example 10; and

FIG. 23 is a view illustrating a structure of the optical element of example 11.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

Optical elements 1 to 3 of the embodiment are explained.

### (Optical Element 1)

First, the optical element 1 of the embodiment is explained. FIG. 2 illustrates the optical element 1 of the embodiment in which an antireflection film is formed. The optical element 1 of the embodiment has a structure in which two high refractive index layers 21 and two low refractive index layers 22 are alternately stacked on an optical member 10 that transmits light. A surface protection layer 31 made of a mixed oxide of Sn and Si is formed on the uppermost low refractive index layer, as an outermost layer. Specifically, a high refractive index layer 21a, a low refractive index layer 22a, a high refractive index layer 21b, a low refractive index layer 22b and the surface protection layer 31 are stacked on the optical member 10 in this order.

The optical member 10 is made of a glass or the like that transmits light and is a substrate, a lens or the like, for example.

The high refractive index layer 21 is made of a material whose refraction index is greater than or equal to 2 such as Ta₂O₅ whose refraction index is 2.1, Si₃N₄ whose refraction index is 2, ZrO₂ whose refraction index is 2.3, TiO₂ whose refraction index is 2.4 or the like.

The low refractive index layer 22 is made of a material whose refraction index is less than or equal to 1.6 such as SiO₂ whose refraction index is 1.45, a mixed oxide of Zr and Si, a mixed oxide of Sn and Si or a mixed oxide of Al and Si.

Here, the refraction index of the high refractive index layer is preferably greater than or equal to 1.7, and more preferably, greater than or equal to 2. Further, the refraction index of the low refractive index layer is preferably less than or equal to 1.7, more preferably, less than or equal to 1.6, and furthermore preferably, less than or equal to 1.5.

The surface protection layer 31 is made of a mixed oxide of Sn and Si. The refraction index of the surface protection layer 31 is greater than or equal to 1.47 and less than or equal to 2.0, preferably, greater than or equal to 1.48 and less than or equal to 1.9, and more preferably, greater than or equal to 1.48 and less than or equal to 1.6. Here, in this embodiment, the “refraction index” means refraction index at wavelength of 600 nm. Here, it is preferable that the high refractive index layer 21, the low refractive index layer 22 and the surface protection layer 31 are amorphous and the high refractive index layer 21, the low refractive index layer 22 and the surface protection layer 31 are formed by sputtering.

When the low refractive index layer 22b is made of a mixed oxide of Si and Sn, the low refractive index layer 22b may be configured to function as the surface protection layer 31. In such a case, the surface protection layer 31 may not be further provided in addition to the low refractive index layer 22b. For the order of the multilayer, the low refractive index layer may be formed above the optical member 10, and not limited to the high refractive index layer.

### (Optical Element 2)

Next, the optical element 2 of the embodiment is explained. FIG. 3 illustrates the optical element 2 of the embodiment in which an antireflection film is formed. The optical element 2 of the embodiment is different from the optical element 1, and has a structure in which two of the high refractive index layers 21 and two of the low refractive index layers 22 are alternately stacked on the optical member 10 that transmits light. A surface protection layer 32 made of a mixed oxide of Zr and Si is formed on the uppermost low refractive index layer, as an outermost layer. Specifically, the high refractive index layer 21a, the low refractive index layer 22a, the high refractive index layer 21b, the low refractive index layer 22b and the surface protection layer 32 are stacked on the optical member 10 in this order.

The optical member 10 is made of a glass or the like that transmits light and is a substrate, a lens or the like, for example.

The high refractive index layer 21 is made of a material whose refraction index is greater than or equal to 2 such as Ta₂O₅ whose refraction index is 2.1, Si₃N₄ whose refraction index is 2, ZrO₂ whose refraction index is 2.3, TiO₂ whose refraction index is 2.4 or the like.

The low refractive index layer 22 is made of a material whose refraction index is less than or equal to 1.6 such as SiO₂ whose refraction index is 1.45, a mixed oxide of Zr and Si, a mixed oxide of Sn and Si or a mixed oxide of Al and Si.

Here, the refraction index of the high refractive index layer is preferably greater than or equal to 1.7, and more preferably, greater than or equal to 2. Further, the refraction index of the low refractive index layer is preferably less than or equal to 1.7, more preferably, less than or equal to 1.6, and furthermore preferably, less than or equal to 1.5.

The surface protection layer 32 is made of a mixed oxide of Zr and Si. The refraction index of the surface protection layer 32 is greater than or equal to 1.47 and less than or equal to 2.0, preferably, greater than or equal to 1.48 and less than or equal to 1.9, and more preferably, greater than or equal to 1.48 and less than or equal to 1.6. Here, it is preferable that the high refractive index layer 21, the low refractive index layer 22 and the surface protection layer 32 are amorphous and the high refractive index layer 21, the low refractive index layer 22 and the surface protection layer 32 are formed by sputtering.

When the low refractive index layer 22b is made of a mixed oxide of Si and Zr, the low refractive index layer 22b may be configured to function as the surface protection layer 32. In such a case, the surface protection layer 32 may not be further provided in addition to the low refractive index layer 22b. For the order of the multilayer, the low refractive index layer may be formed above the optical member 10, and not limited to the high refractive index layer.

### (Optical Element 3)

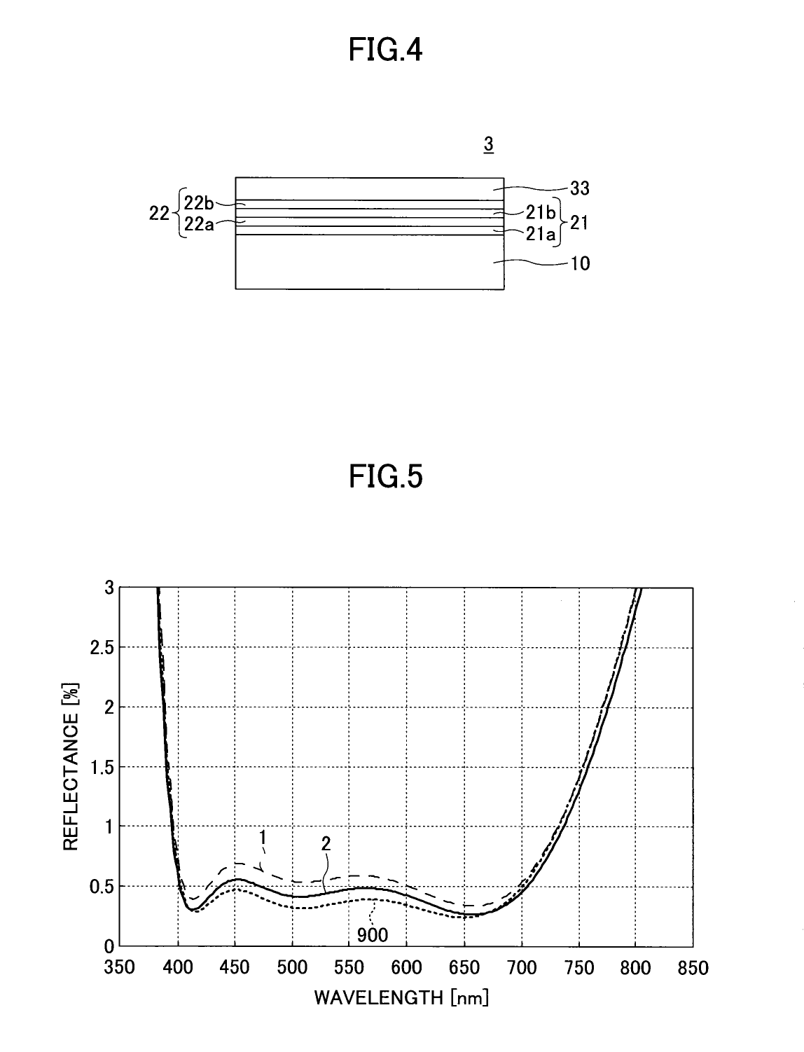

Next, the optical element 3 of the embodiment is explained. FIG. 4 illustrates the optical element 3 of the embodiment in which an antireflection film is formed. The optical element 3 of the embodiment is different from the optical 1 or 2, and has a structure in which two of the high refractive index layers 21 and two of the low refractive index layers 22 are alternately stacked on the optical member 10 that transmits light. A surface protection layer 33 made of a mixed oxide of Al and Si is formed on the uppermost low refractive index layer, as an outermost layer. Specifically, the high refractive index layer 21a, the low refractive index layer 22a, the high refractive index layer 21b, the low refractive index layer 22b and the surface protection layer 33 are stacked on the optical member 10 in this order.

The optical member 10 is made of a glass or the like that transmits light, and may be a substrate, a lens or the like.

The high refractive index layer 21 is made of a material whose refraction index is greater than or equal to 2 such as Ta₂O₅ whose refraction index is 2.1, Si₃N₄ whose refraction index is 2, ZrO₂ whose refraction index is 2.3, TiO₂ whose refraction index is 2.4 or the like.

The low refractive index layer 22 is made of a material whose refraction index is less than or equal to 1.6 such as SiO₂ whose refraction index is 1.45, a mixed oxide of Zr and Si, a mixed oxide of Sn and Si or a mixed oxide of Al and Si.

Here, the refraction index of the high refractive index layer is preferably greater than or equal to 1.7, and more preferably, greater than or equal to 2. Further, the refraction index of the low refractive index layer is preferably less than or equal to 1.7, more preferably, less than or equal to 1.6, and furthermore preferably, less than or equal to 1.5.

The surface protection layer 33 is made of a mixed oxide of Al and Si, and the refraction index of the surface protection layer 33 is greater than or equal to 1.47 and less than or equal to 2.0, preferably, greater than or equal to 1.48 and less than or equal to 1.9, and furthermore preferably, greater than or equal to 1.48 and less than or equal to 1.6. Here, it is preferable that the high refractive index layer 21, the low refractive index layer 22 and the surface protection layer 33 are amorphous and the high refractive index layer 21, the low refractive index layer 22 and the surface protection layer 33 are formed by sputtering.

Here, when the low refractive index layer 22b is made of a mixed oxide of Si and Al, the low refractive index layer 22b may be configured to function as the surface protection layer 33. In such a case, the surface protection layer 33 may not be further provided in addition to the low refractive index layer 22b. For the order of the multilayer, the low refractive index layer may be formed above the optical member 10, and not limited to the high refractive index layer.

### (Characteristics of Optical Elements)

Next, characteristics of the optical elements of the embodiment are explained. In this explanation, the optical element 1 of the embodiment illustrated in FIG. 2 has a structure in which the high refractive index layer 21a made of Ta₂O₅ with a thickness of 13.6 nm, the low refractive index layer 22a made of a SiO₂ film with a thickness of 33.7 nm, the high refractive index layer 21b made of Ta₂O₅ with a thickness of 121.9 nm, the low refractive index layer 22b made of a SiO₂ film with a thickness of 67.6 nm and the surface protection layer 31 with a thickness of 10 nm are stacked on the optical member 10 such as a glass substrate or the like with a thickness of 1.1 mm. The surface protection layer 31 is made of a mixed oxide of Sn and Si and the composition of Sn and Si is adjusted to such that its refraction index becomes about 1.8.

Further, the optical element 2 of the embodiment illustrated in FIG. 3 has a structure in which the high refractive index layer 21a made of Ta₂O₅ with a thickness of 13.7 nm, the low refractive index layer 22a made of a SiO₂ film with a thickness of 33.3 nm, the high refractive index layer 21b made of Ta₂O₅ with a thickness of 121.4 nm, the low refractive index layer 22b made of a SiO₂ film with a thickness of 70.9 nm and the surface protection layer 32 with a thickness of 10 nm are stacked on the optical member 10 such as a glass substrate or the like with a thickness of 1.1 mm. The surface protection layer 32 is made of a mixed oxide of Zr and Si and the composition of Zr and Si is adjusted such that its refraction index becomes about 1.7.

Further, the optical element 3 of the embodiment illustrated in FIG. 4 has a structure in which the high refractive index layer 21a made of Si₃N₄ with a thickness of 14.2 nm, the low refractive index layer 22a made of a SiO₂ film with a thickness of 33.6 nm, the high refractive index layer 21b made of Si₃N₄ with a thickness of 126.8 nm, the low refractive index layer 22b made of a SiO₂ film with a thickness of 76 nm and the surface protection layer 33 with a thickness of 10 nm are stacked on the optical member 10 such as a glass substrate or the like with a thickness of 1.1 mm. The surface protection layer 33 is made of a mixed oxide of Al and Si and the composition of Al and Si is adjusted such that its refraction index becomes about 1.49.

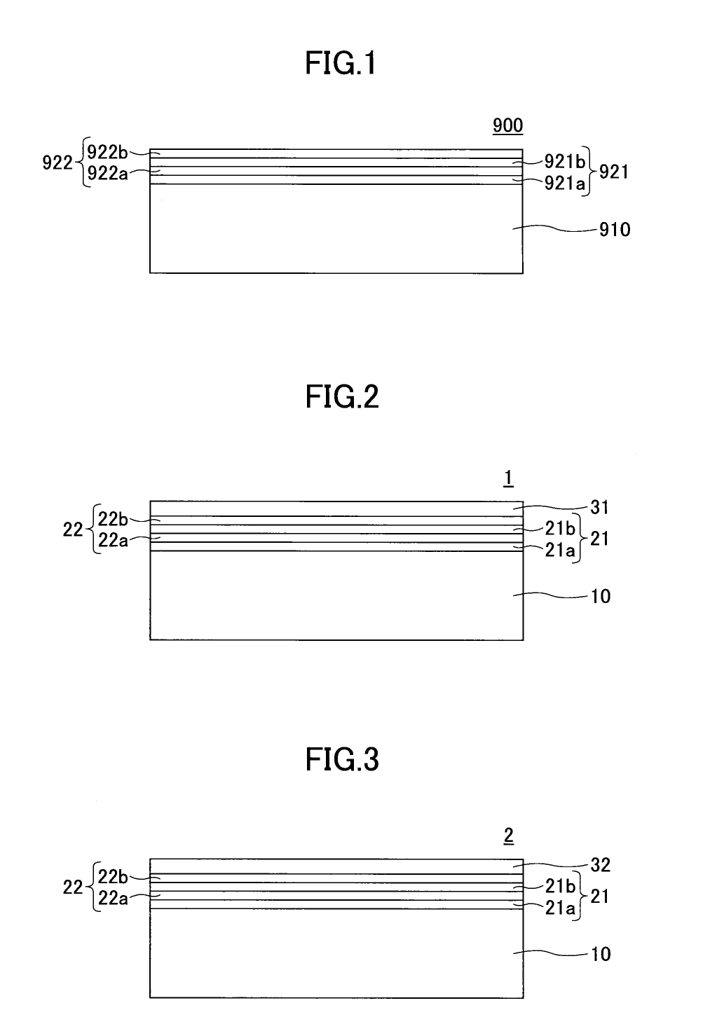

Further, an optical element 900 illustrated in FIG. 1 has a structure in which the high refractive index layer 921a made of Ta₂O₅ with a thickness of 13.7 nm, the low refractive index layer 922a made of a SiO₂ film with a thickness of 33.3 nm, the high refractive index layer 921b made of Ta₂O₅ with a thickness of 121 nm and a low refractive index layer 922b made of a SiO₂ film with a thickness of 86.4 nm are stacked on the optical member 910 such as a glass substrate or the like with a thickness of 1.1 mm.

Antireflection characteristics of the optical elements 1 and 2 of the embodiment are explained with reference to FIG. 5. FIG. 5 illustrates antireflection characteristics of the optical elements 1 and 2 of the embodiment and the optical element 900 illustrated in FIG. 1. The antireflection characteristics become better from the optical element 1 of the embodiment, the optical element 2 of the embodiment and the optical element 900 in this order. Further, for each of the optical elements 1 and 2 of the embodiment, the reflectance is less than or equal to 0.8% within a wavelength range of 400 nm to 700 nm and has a sufficient antireflection function.

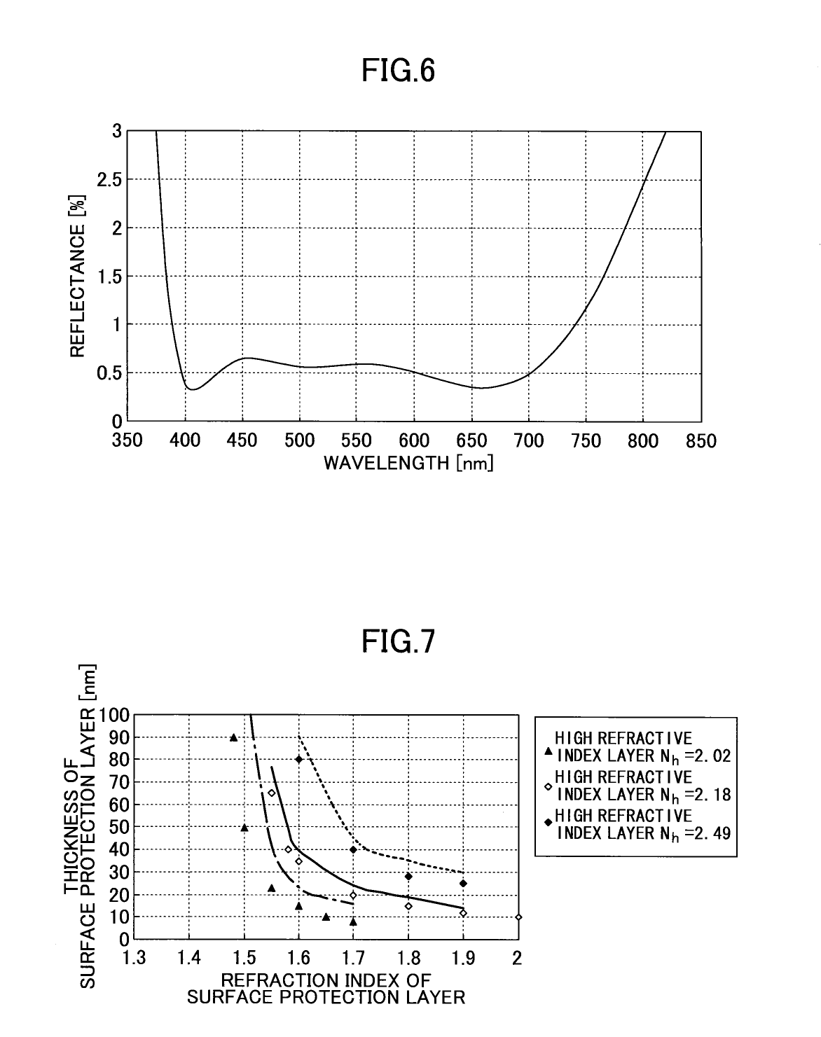

Antireflection characteristics of the optical element 3 of the embodiment are explained with reference to FIG. 6. FIG. 6 illustrates antireflection characteristics of the optical element 3 of the embodiment. For the optical element 3 of the embodiment, the reflectance is less than or equal to 0.8% within a wavelength range of 400 nm to 700 nm and has a sufficient antireflection function.

### (Outermost Layer)

Next, the thickness of the outermost layer of the optical element of the embodiment is explained. The surface protection layers 31, 32 and 33 are formed in the optical elements 1, 2 and 3 of the embodiment, respectively. Here, generally, it is required for the reflectance to become less than or equal to 1% for the antireflection film formed in the optical element.

FIG. 7 illustrates a relationship between the refraction index Nₛ and the thickness dₛ of the surface protection layer 31, 32 or 33 when the reflectance of light whose wavelength range is from 400 nm to 650 nm becomes less than or equal to 1%, when the refraction index Nₕ of the high refractive index layer 21 is varied as 2.02, 2.18 and 2.49, in the optical element of the embodiment. It is observed that when the thickness of the surface protection layer 31, 32 or 33 is greater than or equal to 1 nm, and more preferably greater than or equal to 10 nm, a hard coating effect by forming the surface protection layer 31, 32 or 33 can be significantly obtained. Thus, based on the relationship illustrated in FIG. 7, the thickness dₛ of the surface protection layer 31, 32 or 33 is preferably greater than or equal to 1 nm, and more preferably, greater than or equal to 10 nm and within a range illustrated in equation 1. When the high refractive index layers 21 are made of two or more kinds of materials that have different refraction indexes, Nₕ is defined as the highest refraction index among the high refractive index layers 21.

$${d}_{s} ≦ 650 \times exp \{ \frac{- 14 \times ( {N}_{s} - 1.43 )}{( {N}_{h} - {N}_{s} )} \} + 50 \times ( {N}_{h} - {N}_{s} ) \qquad [ Equation 1 ]$$

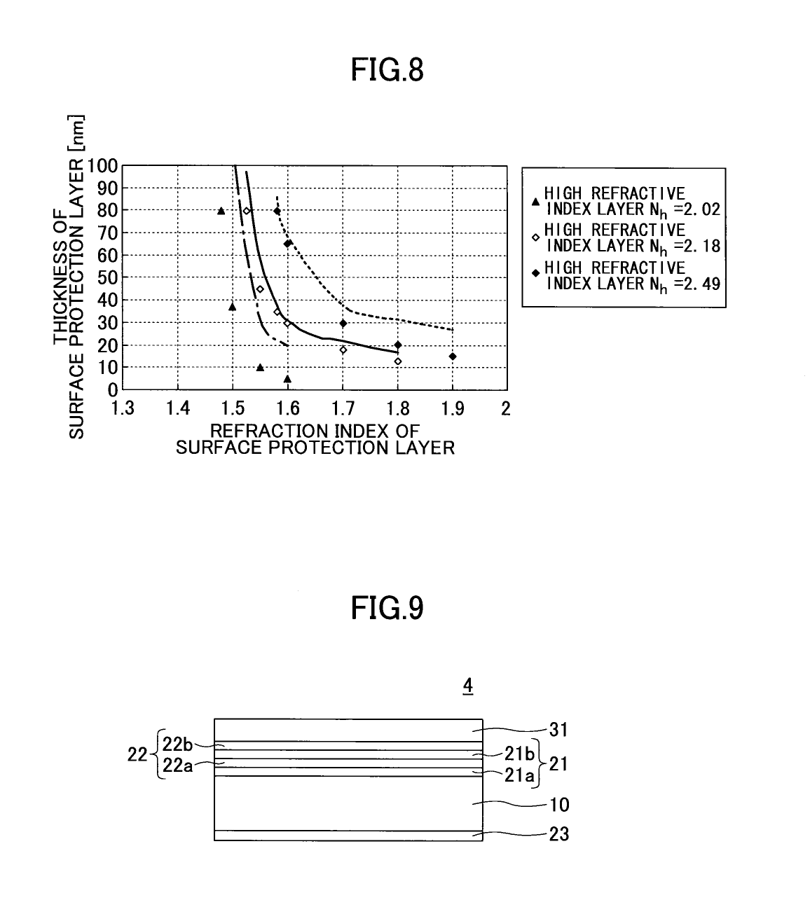

FIG. 8 illustrates a relationship between the refraction index Nₛ and the thickness dₛ of the surface protection layer 31, 32 or 33 when the reflectance at light whose wavelength range is from 400 nm to 650 nm becomes less than or equal to 0.8%, when the refraction index Nₕ of the high refractive index layer 21 is varied as 2.02, 2.18 and 2.49, in the optical element of the embodiment. Based on the relationship illustrated in FIG. 8, the thickness dₛ of the surface protection layer 31, 32 or 33 is preferably greater than or equal to 1 nm, more preferably, greater than or equal to 10 nm, and furthermore preferably, within a range illustrated in equation 2.

$${d}_{s} ≦ 700 \times exp \{ \frac{- 18 \times ( {N}_{s} - 1.44 )}{( {N}_{h} - {N}_{s} )} \} + 45 \times ( {N}_{h} - {N}_{s} ) \qquad [ Equation 2 ]$$

Equation 1 and Equation 2 can be generally expressed as Equation 3. In Equation 3, C1, C2, C3 and C4 are constants. When the reflectance is less than or equal to 1%, Equation 1 is obtained by assuming C1=650, C2=−14, C3=1.43 and C4=50. Further, when the reflectance is less than or equal to 0.8%, Equation 2 can be obtained by assuming C1=700, C2=−18, C3=1.44 and C4=45.

$${d}_{s} ≦ C 1 \times exp \{ \frac{C 2 \times ( {N}_{s} - C 3 )}{( {N}_{h} - {N}_{s} )} \} + C 4 \times ( {N}_{h} - {N}_{s} ) \qquad [ Equation 3 ]$$

Here, in order to have the thickness dₛ of the surface protection layer 31, 32 or 33 to be thicker within a range that satisfies Equation 3, it is necessary to use the surface protection layer 31, 32 or 33 with lower refraction index. When forming mixed oxide of Sn and Si as the surface protection layer 31 by sputtering, as it is difficult to manufacture a mixed target of Sn and Si in which the containing amount of Sn is less than or equal to 10 atm %, in order to make the refraction index of the surface protection layer 31 less than or equal to 1.53, it is necessary to use two or more targets, for example, a mixed target of Sn and Si, and a Si target. Here, although it is possible to form a mixed oxide of Sn and Si by sputtering using a mixed oxide target of Sn and Si, it is more preferable to use a mixed target of Sn and Si from the viewpoint of productivity.

Further, when forming a mixed oxide of Zr and Si as the surface protection layer 32 by sputtering, as it is difficult to manufacture a mixed target of Zr and Si in which the containing amount of Zr is less than or equal to 10 atm %, in order to make the refraction index of the surface protection layer 32 less than or equal to 1.53, it is necessary to use two or more targets, for example, a mixed target of Zr and Si, and a Si target. Here, although it is possible to form a mixed oxide of Zr and Si by sputtering using a mixed oxide target of Zr and Si, it is more preferable to use a mixed target of Zr and Si from the viewpoint of productivity.

Meanwhile, when forming mixed oxide of Al and Si as the surface protection layer 33 by sputtering, as it is possible to manufacture a mixed target of Al and Si in which the containing amount of Al is less than or equal to 10 atm %, the surface protection layer 33 whose refraction index is less than or equal to 1.53 can be obtained without using two or more targets. Thus, when forming a structure in which the low refractive index layer 22b is formed as the same as the surface protection layer to function as surface protection layer and the surface protection layer is not further provided, it is more preferable to form a mixed oxide of Al and Si as the low refractive index layer 22b compared with a case when a mixed oxide of Sn and Si is formed as the low refractive index layer 22b, or a mixed oxide of Zr and Si is formed as the low refractive index layer 22b, from the viewpoint of a wide range of the refraction index and the thickness of the surface protection layer capable of obtaining low reflectance, variety of usable film deposition apparatuses, and cost.

Here, although it is possible to form a mixed oxide of Al and Si by sputtering using a single mixed oxide target, it is more preferable to use a mixed target of Al and Si from the viewpoint of productivity.

### (Optical Member)

The optical member 10 that composes the optical element of the embodiment is explained. The optical member 10 is a lens, a substrate or the like, and made of a so-called “strengthened glass”.

For the optical member 10, a chemically strengthened cover glass such as a Dragontrail™ glass (commercial name, manufactured by Asahi Glass Co., LTD.), a Gorilla glass (commercial name, manufactured by Corning Incorporated), a SCHOTT Xensation™ cover (commercial name, manufactured by SCHOTT), or a SCHOTT Xensation™ cover 3D (manufactured by SCHOTT) may be used.

The optical member 10 may be a chemically strengthened glass including, in terms of an oxide, 62 to 68 mol % of SiO₂, 6 to 12 mol % of Al₂O₃, 7 to 13 mol % of MgO, 9 to 17 mol % of Na₂O and 0 to 7 mol % of K₂O, wherein a difference obtained by subtracting the containing amount of Al₂O₃ from the total containing amount of Na₂O and K₂O is less than 10 mol % and the containing amount of ZrO₂, if included, is less than or equal to 0.8 mol %. For example, the optical member 10 may be a chemically strengthened glass including, in terms of an oxide, SiO₂: 64 mol %, Al₂O₃: 8 mol %, MgO: 11 mol %, Na₂O: 12.5 mol % and ZrO₂: 0.5 mol %.

Further, the optical member 10 may be an alkali aluminosilicate glass and a chemically strengthened glass made of a composition of, in terms of an oxide, 60 to 70 mol % of SiO₂, 6 to 14 mol % of Al₂O₃, 0 to 15 mol % of B₂O₃, 0 to 15 mol % of Li₂O, 0 to 20 mol % of Na₂O, 0 to 10 mol % of K₂O, 0 to 8 mol % of MgO, 0 to 10 mol % of CaO, 0 to 5 mol % of ZrO₂, 0 to 1 mol % of SnO₂, 0 to 1 mol % of CeO₂, less than 50 ppm of As₂O₃ and less than 50 ppm of Sb₂O₃, wherein 12 mol %≦Li₂O+Na₂O+K₂O≦20 mol % and 0 mol %≦MgO+CaO≦10 mol %.

Further, the optical member 10 may be a chemically strengthened glass including, in terms of an oxide, 63.0 to 67.5 mol % of SiO₂, 9.5 to 12.0 mol % of Al₂O₃, 8.5 to 15.5 mol % of Na₂O, 2.5 to 4.0 mol % of K₂O, 3.0 to 9.0 mol % of MgO, 0 to 2.5 mol % of Σ(CaO+SrO+BaO+ZnO), 0.5 to 1.5 mol % of TiO₂, 0.02 to 0.5 mol % of CeO₂, 0 to 0.35 mol % of As₂O₃, 0 to 1.0 mol % of SnO₂ and 0.05 to 2.6 mol % of F₂, wherein SiO₂/Al₂O₃ is 5.3 to 6.85, Na₂O/K₂O is 3.0 to 5.6, Al₂O₃/K₂O is 2.8 to 3.6 and Al₂O₃/(TiO₂+CeO₂) is 7.6 to 18.5.

Although the optical member 10 is explained as a so-called “strengthened glass”, the optical member 10 may be made of any material that transmits light, and may be a normal glass, quartz, crystal, sapphire, a resin material such as poly-carbonate or the like, or the like, for example. Among these materials, sapphire is preferably used due to its strength or hardness as a base material.

### (Optical Element 4)

Next, an optical element 4 of the embodiment is explained. As illustrated in FIG. 9, the optical element 4 of the embodiment has a structure in which an ultraviolet and infrared ray reflection film 23 is further formed at a surface of the optical member 10 opposite to the surface where the surface protection layer 31 is formed in addition to the structure of the optical element 1 of the embodiment.

The ultraviolet and infrared ray reflection film 23 is made of a dielectric multilayer film in which dielectric layers A and dielectric layers B whose refraction index is higher than that of the dielectric layers A are alternately stacked with each other by sputtering, a vacuum deposition method or the like.

For the material of the dielectric layer A, a material whose refraction index is less than or equal to 1.6, and more preferably, between 1.2 and 1.6 is used. Specifically, silica (SiO₂), alumina, lanthanum fluoride, magnesium fluoride, trisodium hexafluoroaluminate or the like is used. For the material of the dielectric layer B, a material whose refraction index is greater than or equal to 1.7, and more preferably, between 1.7 and 2.5 is used. Specifically, titania (TiO₂), zirconia, tantalum pentoxide, niobium pentoxide, lanthanum oxide, yttria, zinc oxide, zinc sulfide or the like is used. Here, the refraction index means the refraction index with respect to light whose wavelength is 550 nm.

The ultraviolet and infrared ray reflection film 23 may not be limited to the above structure and any material can be used as long as it has an ultraviolet and infrared ray reflection. Further, it is not limited to a dielectric multilayer film, and resin including pigment or dye, a colored glass or the like may be used.

The dielectric multilayer film may be formed by an ion beam method, an ion plating method, CVD or the like in addition to the above described sputtering or the vacuum deposition method. As the sputtering or the ion plating method is performed in a so-called “plasma atmosphere”, adhesion to the optical member 10 can be improved.

### (Specific Examples of Optical Element 4)

Next, specific examples of the optical element 4 of the embodiment are explained. The optical member 10 is a chemically strengthened glass having a circular shape of φ6 mm×0.6 mm and including, in terms of an oxide, 64 mol % of SiO₂, 8 mol % of Al₂O₃, 11 mol % of MgO, 12.5 mol % of Na₂O and 0.5 mol % of ZrO₂. The optical element 4 further includes the high refractive index layer 21a made of Ta₂O₅ with a thickness of 13.6 nm, the low refractive index layer 22a made of a SiO₂ film with a thickness of 33.7 nm, the high refractive index layer 21b made of Ta₂O₅ with a thickness of 121.9 nm, the low refractive index layer 22b made of a SiO₂ film with a thickness of 67.6 nm and the surface protection layer 31 with a thickness of 10 nm that are formed by sputtering and stacked on one of the surfaces of the optical member 10.

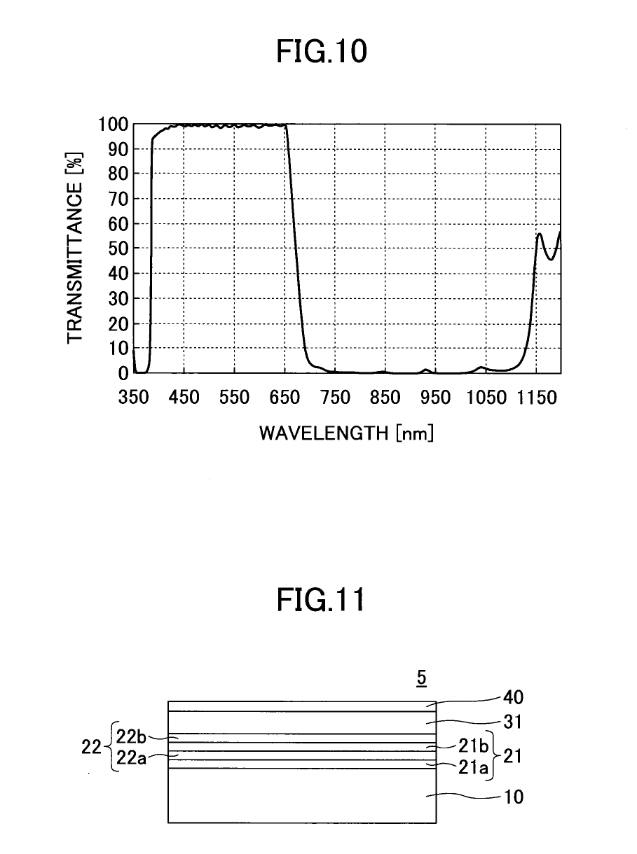

The surface protection layer 31 is made of a mixed oxide of Sn and Si and the composition of Sn and Si is adjusted such that the refraction index becomes about 1.8. Further, the ultraviolet and infrared ray reflection film 23 having the structure illustrated in Table 1 is formed on a surface of the optical member 10 that is opposite to the surface where the antireflection film was formed. FIG. 10 illustrates a spectral transmittance curve (incident angle is 0) of the ultraviolet and infrared ray reflection film 23. The spectral transmittance curve illustrated in FIG. 10 is measured using a spectrophotometer (MCPD-3000, manufactured by OTSUKA ELECTRONICS CO. LTD.).

TABLE 1

| | | PHYSICAL |
|---|---|---|
| | | THICKNESS |
| | MATERIAL | (nm) |
| 1st layer | TiO₂ | 13.65 |
| 2nd layer | SiO₂ | 33.09 |
| 3rd layer | TiO₂ | 113.88 |
| 4th layer | SiO₂ | 171.51 |
| 5th layer | TiO₂ | 108.51 |
| 6th layer | SiO₂ | 176.41 |
| 7th layer | TiO₂ | 110.96 |
| 8th layer | SiO₂ | 176.88 |
| 9th layer | TiO₂ | 110.06 |
| 10th layer | SiO₂ | 176.77 |
| 11th layer | TiO₂ | 111.64 |
| 12th layer | SiO₂ | 176.33 |
| 13th layer | TiO₂ | 110.14 |
| 14th layer | SiO₂ | 176.63 |
| 15th layer | TiO₂ | 108.76 |
| 16th layer | SiO₂ | 174.28 |
| 17th layer | TiO₂ | 103.25 |
| 18th layer | SiO₂ | 158.13 |
| 19th layer | TiO₂ | 88.1 |
| 20th layer | SiO₂ | 147.6 |
| 21th layer | TiO₂ | 84.86 |
| 22th layer | SiO₂ | 140.42 |
| 23th layer | TiO₂ | 834 |
| 24th layer | SiO₂ | 137.79 |
| 25th layer | TiO₂ | 83.18 |
| 26th layer | SiO₂ | 137.18 |
| 27th layer | TiO₂ | 82.4 |
| 28th layer | SiO₂ | 139.9 |
| 29th layer | TiO₂ | 82.51 |
| 30th layer | SiO₂ | 140.73 |
| 31th layer | TiO₂ | 83.62 |
| 32th layer | SiO₂ | 147.28 |
| 33th layer | TiO₂ | 85.56 |
| 34th layer | SiO₂ | 67.83 |

### (Optical Element 5)

Next, an optical element 5 of the embodiment is explained. As illustrated in FIG. 11, the optical element 5 of the embodiment has a structure in which an antifouling coating layer 40 with a thickness of less than 20 nm is further formed on the surface protection layer 31 of the optical element 1 of the embodiment.

Here, the antifouling coating layer 40 is a so-called “Anti Finger Print (AFP)” and is made of an antifouling coating agent illustrated in chemical formula 1.

R_{f}—R¹—SiX₃₋ₓR²ₓ [Chemical formula 1]

The antifouling coating agent illustrated in chemical formula 1 includes fluorinated siloxane generated by applying a coating composition containing fluorinated silane.

“R_{f}” is perfluoro group of 2-400C including oxygen atom between each of one or more carbon bond(s).

“R¹” is a carbon chain of 2-16C composed of either or both of alkylene group and arylene group, and one or more carbon atom(s) may be substituted by heteroatom selected from oxygen, nitrogen and sulfur, a functional group selected from carbonyl, amide and sulfonamide. Here, when a substituent group is included, the carbon number, other than the substituent group, is 2 to 16. “R²” is independently 1-6C alkyl group. “X” is independently halogen, or an alkoxy group or an acyloxy group of 1-6C. “x” is 0 or 1.

For the material of the antifouling coating layer 40, a compound expressed by following Chemical formula 2 or Chemical formula 3 may be used.

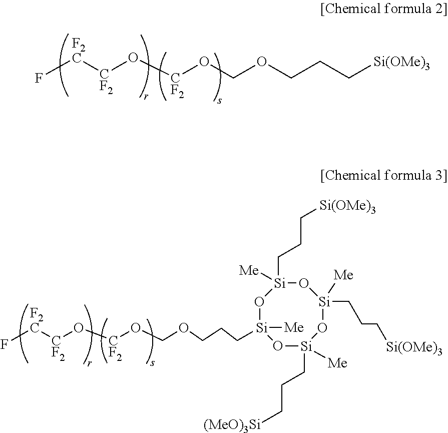

In chemical formula 2 and in chemical formula 3, “Me” expresses methyl group. Each of “r” and “s” is an integer from 1 to 200, r+s (average)=40 and r/s=0.8 to 0.95

The antifouling coating agent of the embodiment may be applied to the antireflection film of the optical member 10 by various methods. Preferably, the antireflection film is processed by a coating composition (normally, solution) containing fluorine-substituted silane (in other words, fluorinated silane) including heteroatom or an organic portion including a functional group. This process may be performed on all of the surfaces or a part of one surface of the base material, but advantageously, this process may only be performed on the antireflection film of the optical member 10. Various processing methods such as spraying, casting, roll coating, immersion or the like may be used, but preferably, the optical member 10 is immersed in the coating composition. This method is preferable because the discharging about of solution is small and risk of damaging the antireflection film of the optical member 10 is low. The coating composition is normally relatively diluted solution, and preferably containing about less than 2.0 wt. % of fluorinated silane, more preferably, containing about less than 0.5 wt. % of fluorinated silane, and most preferably, containing about less than 0.3 wt. % of fluorinated silane.

The important thing is to contact an object to be coated with the coating composition (normally, coating solution) at room temperature (in other words, about 20° C. to about 25° C.) for a relatively short period. The base material is pulled up at a speed that an antireflection surface preferably substantially exhibits self-incompatibility (in other words, substantially completely dried and a film or drop of the coating composition does not adhered almost not at all or not at all) after contacting with the coating composition for a short period (in case of immersion). Normally, contacting time (in other words, total time that the antireflection film of the optical member 10 contacts the coating composition) is less than about 30 minutes. Preferably, the contacting time is less than about 20 minutes, more preferably, less than about 10 minutes, and most preferably, less than about 5 minutes.

The important thing is, according to the preferable embodiment, it is possible to actualize desired antifouling characteristics or recover the antireflection characteristics without performing an after-treatment of forming the antifouling film including curing of the film by baking at high temperature, polishing, washing with solvent or the like. In order to avoid excess amounts of coating composition remaining on the antireflection film of the optical member 10, the antireflection film of the optical member 10 which is sufficiently cleaned is used and the antireflection film of the optical member 10 is pulled out from the coating composition at a sufficiently slow speed (normally at a speed of about 0.1 cm/sec to about 2.5 cm/sec, preferably at a speed of about 0.5 cm/sec). Although the optical element 5 is explained such that the antifouling coating layer 40 is formed on the surface protection layer 31 above, the antifouling coating layer 40 may be formed on a structure in which the high refractive index layers 21 and the low refractive index layers 22 are formed, without forming the surface protection layer 31.

It is preferable that the thickness of the antifouling coating layer 40 is less than or equal to 20 nm because the influence on the optical characteristics of the dielectric multilayer film can be made small. However, the antifouling coating layer 40 may be made thicker. The antifouling coating layer 40 is not limited to the antifouling coating agent illustrated in chemical formula 1, and an organic material such as fluorine containing resin or the like may be used. Further, silicone-based resin may be used as the antifouling coating layer 40. As an example of the silicone-based resin, silicone oil or the like may be used.

### (Optical Element 6)

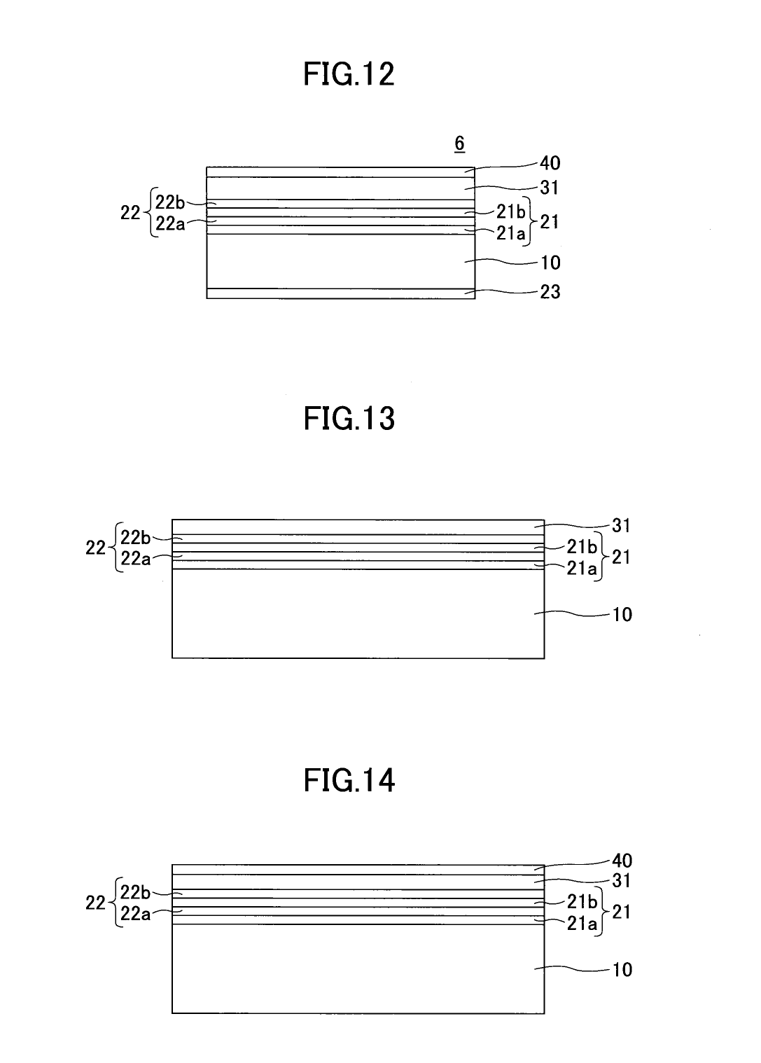

Next, an optical element 6 of the embodiment is explained. As illustrated in FIG. 12, the optical element 6 of the embodiment has a structure in which the antifouling coating layer 40 with a thickness of less than 20 nm is further formed on the surface protection layer 31 and the ultraviolet and infrared ray reflection film 23 is further formed on a surface that is opposite to the surface where the surface protection layer 31 is formed, of the optical element 1 of the embodiment. As the antifouling coating layer 40 is similar to that of the optical element 5 and the ultraviolet and infrared ray reflection film 23 is similar to that of the optical element 4, the detailed explanation is not repeated.

Here, for the optical element 2 or 3 of the embodiment, similar structures as the optical elements 4 to 6 may be applied. Further, instead of the surface protection layer 31, 32 or 33, a Diamond-like Carbon (DLC) may be formed as the outermost front surface. The DLC may be formed on the surface protection layer 31, 32 or 33.

### (High Refractive Index Layer 21 and Low Refractive Index Layer 22)

Next, the materials that compose the high refractive index layer 21 and the low refractive index layer 22 are explained. In this embodiment, it is more preferable that the high refractive index layer 21 and the low refractive index layer 22 are made of hard materials. Specifically, it is preferable that the stiffness constant C33 of the material is greater than or equal to 7×10¹⁰ N/m² and more preferably, greater than or equal to 17×10¹⁰ N/m². Specifically, SiO₂ (8.3×10¹⁰ N/m²), Nb₂O₅ (12.9×10¹⁰ N/m²), Ta₂O₅ (16.6×10¹⁰ N/m²), ZrO₂ (20 to 24×10¹⁰ N/m²), TiO₂ (22.8 to 28×10¹⁰ N/m²), Si₃N₄ (30.4×10¹⁰ N/m²), Al₂O₃ (39.3×10¹⁰ N/m²) or DLC (10 to 80×10¹⁰ N/m²) is preferably used, and further, among them, ZrO₂ (20 to 24×10¹⁰ N/m²), TiO₂ (22.8 to 28×10¹⁰ N/m²), Si₃N₄ (30.4×10¹⁰ N/m²) or Al₂O₃ (39.3×10¹⁰ N/m²) is preferably used. For a deposition method of the multilayer film, sputtering, a vacuum deposition method or the like may be used, and it is preferable to use sputtering, digital sputtering or the like so that high hardness deposition can be performed.

### (Coefficient of Dynamic Friction or the Like of Surface Protection Layers 31, 32 and 33, and Antifouling Coating Layer 40)

It is preferable that a value of the coefficient of dynamic friction of each of the surface protection layers 31, 32 and 33 and the antifouling coating layer 40, which becomes an outermost surface of the optical element of the embodiment, is low. Specifically, it is preferable that the coefficient of dynamic friction is less than or equal to 0.45, more preferably, less than or equal to 0.35, and furthermore preferably, less than or equal to 0.25.

Further, for the deposition method of the outermost surface such as the surface protection layer 31, 32 or 33 or the like, a deposition method such as sputtering or the like may be used. At this time, while depositing the layer, by performing ion irradiation, plasma irradiation, applying a bias voltage to a substrate side or the like, the deposited surface can be made smooth and a layer with a small coefficient of friction can be obtained or the like. In ion irradiation, plasma irradiation or applying the bias voltage to the substrate side, argon, oxygen or the like may be used as the gas and a linear ion source (LIS) or the like may be used as the ion source. When performing ion irradiation, plasma irradiation or the like, a film deposition chamber in which sputtering is performed, and an irradiation chamber in which an irradiation source for ion irradiation, plasma irradiation or the like is provided may be separately provided and deposition and ion irradiation, plasma irradiation or the like may be alternately performed. Here such a deposition method may be used for forming the high refractive index layer 21 and the low refractive index layer 22.

### EXAMPLES

The optical elements of examples 1 to 12 are explained in the following in order to explain examples of the embodiment. In examples 1 to 11, a chemically strengthened glass was used as the optical member 10, which was a base material, and sapphire was used as the optical member 10 in example 12.

### Example 1

Example 1 of the embodiment is explained. FIG. 13 illustrates a structure of the optical element of example 1. The optical element of example 1 had a structure in which the high refractive index layers 21 (21a, 21b) and the low refractive index layers 22 (22a, 22b) were alternately stacked on the optical member 10, and further the surface protection layer 31 was formed thereon.

First, the optical member 10 that was cleaned by deionized water and alcohol was prepared and set at a substrate holder of a thin film deposition apparatus.

After the degree of vacuum of the thin film deposition apparatus became less than or equal to 2×10⁻⁴ Pa, sputtering was performed using a Ta target with an incident power of 3 kW while introducing argon gas at 40 sccm and oxygen gas at 180 sccm to form the high refractive index layer 21a with a thickness of 14 nm and refraction index (n) of 2.20 on the optical member 10. Next, sputtering was performed using a Si target with an incident power of 6 kW while introducing argon gas at 30 sccm and oxygen gas at 180 sccm to form the low refractive index layer 22a with a thickness of 34 nm and refraction index (n) of 1.48 on the high refractive index layer 21a.

Thereafter, the high refractive index layer 21b with a thickness of 121 nm was formed on the low refractive index layer 22a by using the same material and by the same manufacturing method as the above described high refractive index layer 21a. Further, the low refractive index layer 22b with a thickness of 71 nm was formed on the high refractive index layer 21b by using the same material and by the same manufacturing method as the above described low refractive index layer 22a.

Next, sputtering was performed using a Sn containing Si target and a Si target with incident powers 0.6 kW and 6 kW, respectively, while introducing argon gas at 80 sccm and oxygen gas at 140 sccm to form the surface protection layer 31 with a thickness of 10 nm and refraction index (n) of 1.51 on the low refractive index layer 22b.

### Example 2

Example 2 of the embodiment is explained. FIG. 14 illustrates a structure of the optical element of example 2. The optical element of example 2 had a structure in which the high refractive index layers 21 (21a, 21b) and the low refractive index layers 22 (22a, 22b) were alternately stacked on the optical member 10, further, the surface protection layer 31 was formed and the antifouling coating layer 40 was formed on the surface protection layer 31.

First, the optical member 10 that was cleaned by deionized water and alcohol was prepared and set at a substrate holder of a thin film deposition apparatus.

After the degree of vacuum of the thin film deposition apparatus became less than or equal to 2×10⁻⁴ Pa, sputtering was performed using a Ta target with an incident power of 3 kW while introducing argon gas at 40 sccm and oxygen gas at 180 sccm to form the high refractive index layer 21a with a thickness of 14 nm and refraction index (n) of 2.20 on the optical member 10. Next, sputtering was performed using a Si target with an incident power of 6 kW while introducing argon gas at 30 sccm and oxygen gas at 180 sccm to form the low refractive index layer 22a with a thickness of 34 nm and refraction index (n) of 1.48 on the high refractive index layer 21a.

Thereafter, the high refractive index layer 21b with a thickness of 121 nm was formed on the low refractive index layer 22a by using the same material and by the same manufacturing method as the above described high refractive index layer 21a. Further, the low refractive index layer 22b with a thickness of 71 nm was formed on the high refractive index layer 21b by using the same material and by the same manufacturing method as the above described low refractive index layer 22a.

Next, sputtering was performed using a Sn containing Si target and a Si target with incident powers 0.6 kW and 6 kW, respectively, while introducing argon gas at 80 sccm and oxygen gas at 140 sccm to form the surface protection layer 31 with a thickness of 10 nm and refraction index (n) of 1.51 on the low refractive index layer 22b.

Next, the antifouling coating layer 40 with a thickness of 7 nm was formed on the surface protection layer 31 by depositing a fluorine-based oil repellent agent (commercial name “Optool DSX”, manufactured by DAIKIN INDUSTRIES).

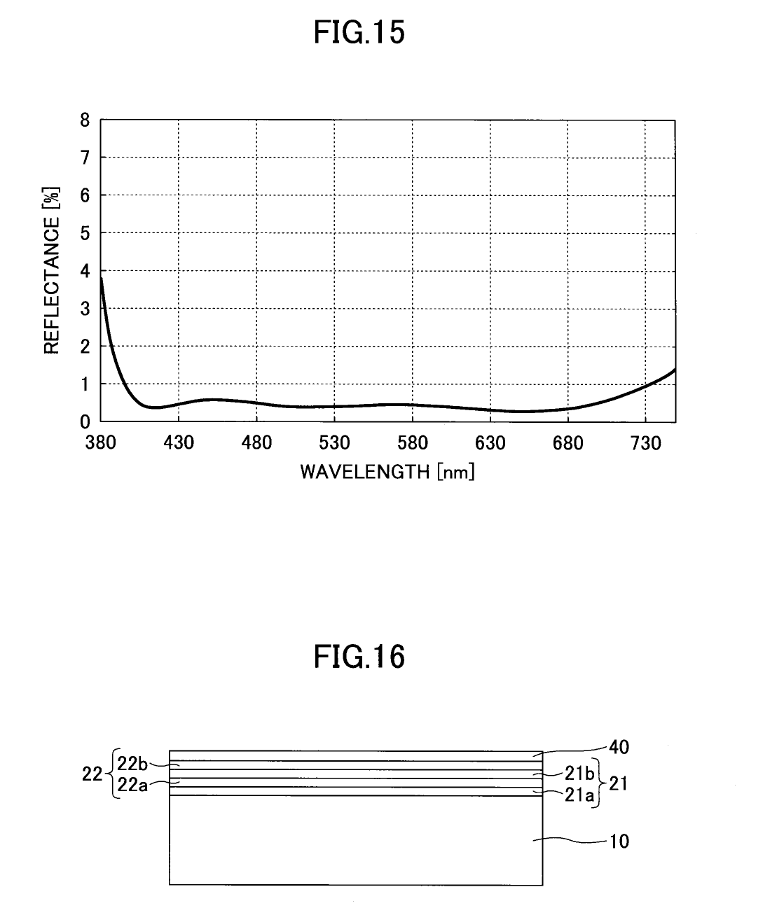

FIG. 15 is a view illustrating an example of reflectance characteristics designed when manufacturing the optical element of example 2.

### Example 3

Example 3 of the embodiment is explained. FIG. 16 illustrates a structure of the optical element of example 3. The optical element of example 3 had a structure in which the high refractive index layers 21 (21a, 21b) and the low refractive index layers 22 (22a, 22b) were alternately stacked on the optical member 10, and further the antifouling coating layer 40 was formed.

First, the optical member 10 that was cleaned by deionized water and alcohol was prepared and set at a substrate holder of a thin film deposition apparatus.

After the degree of vacuum of the thin film deposition apparatus became less than or equal to 2×10⁻⁴ Pa, sputtering was performed using a Si target with an incident power of 6 kW while introducing argon gas at 85 sccm and nitrogen gas at 105 sccm to form the high refractive index layer 21a with a thickness of 26 nm and refraction index (n) of 2.06 on the optical member 10. Next, sputtering was performed using a Sn containing Si target and a Si target with incident powers 0.6 kW and 6 kW, respectively, while introducing argon gas at 80 sccm and oxygen gas at 140 sccm to form the low refractive index layer 22a with a thickness of 30 nm and refraction index (n) of 1.51 on the high refractive index layer 21a.

Thereafter, the high refractive index layer 21b with a thickness of 50 nm was formed on the low refractive index layer 22a by using the same material and by the same manufacturing method as the above described high refractive index layer 21a. Further, the low refractive index layer 22b with a thickness of 88 nm was formed on the high refractive index layer 21b by using the same material and by the same manufacturing method as the above described low refractive index layer 22a.

Next, the antifouling coating layer 40 with a thickness of 7 nm was formed on the low refractive index layer 22b by depositing a fluorine-based oil repellent agent (commercial name “Optool DSX”, manufactured by DAIKIN INDUSTRIES).

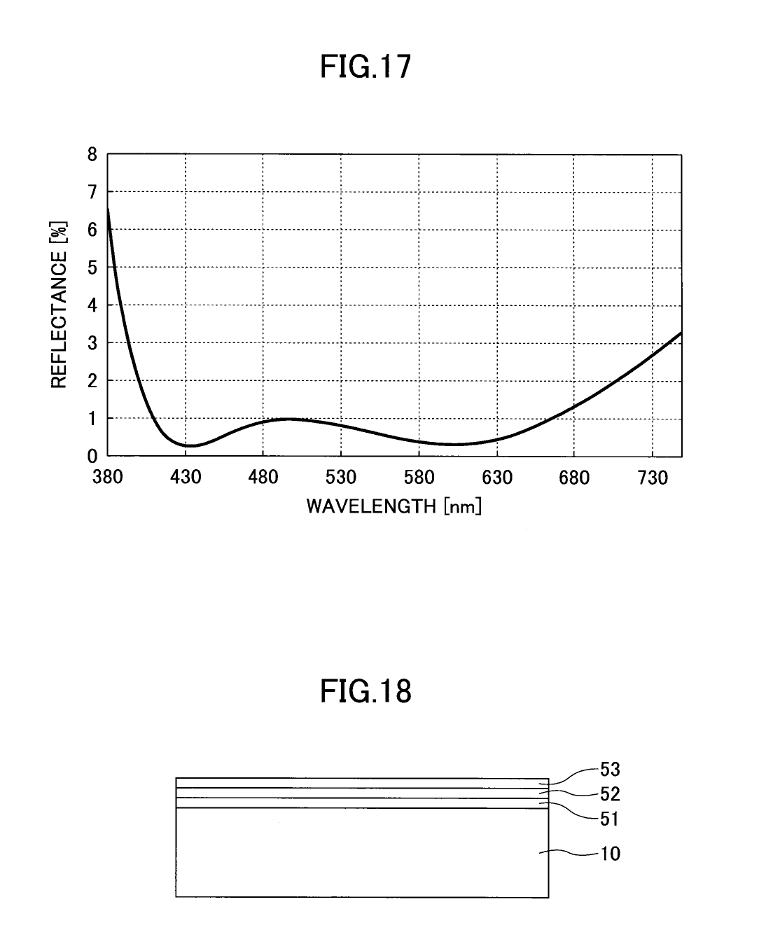

FIG. 17 is a view illustrating an example of reflectance characteristics designed when manufacturing the optical element of example 3.

### Example 4

Example 4 of a comparative example of the embodiment is explained. FIG. 18 illustrates a structure of the optical element of example 4. The optical element of example 4 had a structure in which a low refractive index layer 51, a high refractive index layer 52 and a low refractive index layer 53 were stacked on the optical member 10.

First, the optical member 10 that was cleaned by deionized water and alcohol was prepared and set at a substrate holder of a thin film deposition apparatus.

The low refractive index layer 51 made of Al₂O₃ with a thickness of 58 nm was formed on the optical member 10 by sputtering. Next, the high refractive index layer 52 made of ZrO₂ with a thickness of 127 nm was formed on the low refractive index layer 51. Next, the low refractive index layer 53 made of MgF₂ with a thickness of 89 nm was formed on the high refractive index layer 52 by a vacuum deposition method.

### Example 5

Example 5 of the embodiment is explained. The optical element of example 5 had a structure in which DLC with a thickness of 3 nm was deposited on the surface protection layer 31 of the optical element of example 1.

### Example 6

Example 6 of the embodiment is explained. The optical element of example 6 has a structure including the optical element in which the high refractive index layers 21 (21a, 21b) and the low refractive index layers (22a, 22b) were alternately stacked on the optical member 10, similar to example 3, and further DLC with a thickness of 3 nm was formed on the optical element.

### Example 7

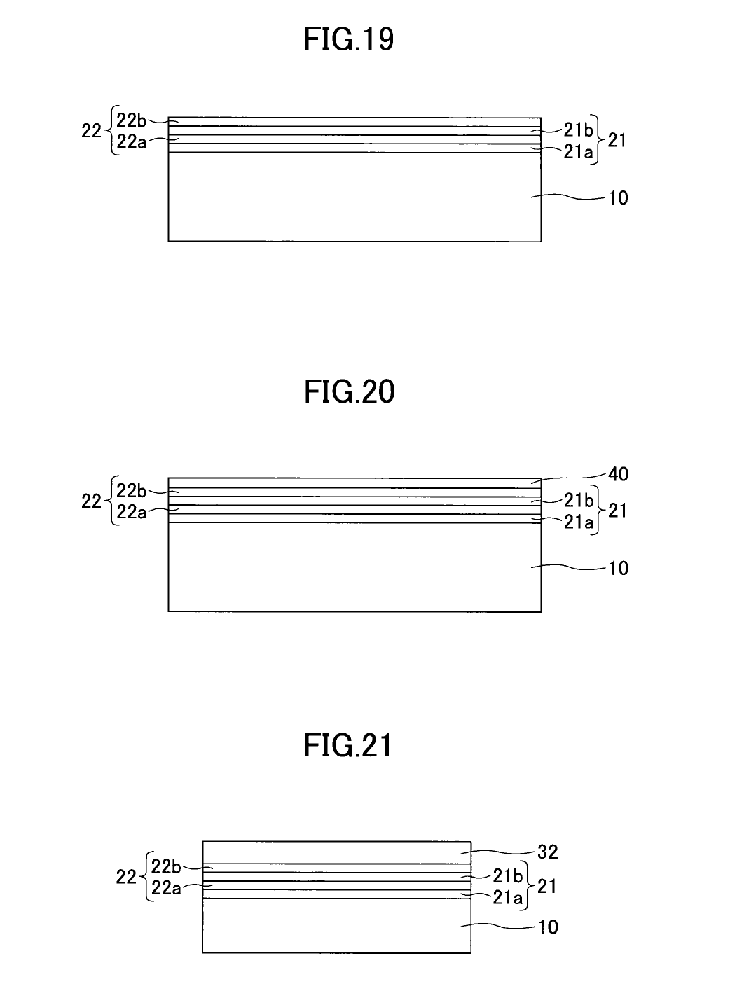

Example 7 of a comparative example of the embodiment is explained. FIG. 19 illustrates a structure of the optical element of example 7. The optical element of example 7 had a structure in which the high refractive index layers 21 (21a, 21b) and the low refractive index layers 22 (22a, 22b) were alternately stacked on the optical member 10.

First, the optical member 10 that was cleaned by deionized water and alcohol was prepared and set at a substrate holder of a thin film deposition apparatus.

After the degree of vacuum of the thin film deposition apparatus became less than or equal to 2×10⁻⁴ Pa, sputtering was performed using a Ta target with an incident power of 3 kW while introducing argon gas at 40 sccm and oxygen gas at 180 sccm to form the high refractive index layer 21a with a thickness of 14 nm and refraction index (n) of 2.20 on the optical member 10. Next, sputtering was performed using a Si target with an incident power of 6 kW while introducing argon gas at 30 sccm and oxygen gas at 180 sccm to form the low refractive index layer 22a with a thickness of 33 nm and refraction index (n) of 1.48 on the high refractive index layer 21a.

Thereafter, the high refractive index layer 21b with a thickness of 121 nm was formed on the low refractive index layer 22a by using the same material and by the same manufacturing method as the above described high refractive index layer 21a. Further, the low refractive index layer 22b with a thickness of 81 nm was formed on the high refractive index layer 21b by using the same material and by the same manufacturing method as the above described low refractive index layer 22a.

### Example 8

Example 8 of the embodiment is explained. FIG. 20 illustrates a structure of the optical element of example 8. The optical element of example 8 had a structure in which the high refractive index layers 21 (21a, 21b) and the low refractive index layers 22 (22a, 22b) were alternately stacked on the optical member 10, and further the antifouling coating layer 40 was formed thereon.

First, the optical member 10 that was cleaned by deionized water and alcohol was prepared and set at a substrate holder of a thin film deposition apparatus.

After the degree of vacuum of the thin film deposition apparatus became less than or equal to 2×10⁻⁴ Pa, sputtering was performed using a Ta target with an incident power of 3 kW while introducing argon gas at 40 sccm and oxygen gas at 180 sccm to form the high refractive index layer 21a with a thickness of 14 nm and refraction index (n) of 2.20 on the optical member 10. Next, sputtering was performed using a Si target with an incident power of 6 kW while introducing argon gas at 30 sccm and oxygen gas at 180 sccm to form the low refractive index layer 22a with a thickness of 33 nm and refraction index (n) of 1.48 on the high refractive index layer 21a.

Thereafter, the high refractive index layer 21b with a thickness of 121 nm was formed on the low refractive index layer 22a by using the same material and by the same manufacturing method as the above described high refractive index layer 21a. Further, the low refractive index layer 22b with a thickness of 81 nm was formed on the high refractive index layer 21b by using the same material and by the same manufacturing method as the above described low refractive index layer 22a.

Next, the antifouling coating layer 40 with a thickness of 7 nm was formed on the low refractive index layer 22b by depositing a fluorine-based oil repellent agent (commercial name “Optool DSX”, manufactured by DAIKIN INDUSTRIES).

### Example 9

Example 9 of the embodiment is explained. FIG. 21 illustrates a structure of the optical element of example 9. The optical element of example 9 had a structure in which the high refractive index layers 21 (21a, 21b) and the low refractive index layers 22 (22a, 22b) were alternately stacked on the optical member 10, and further the surface protection layer 32 was formed.

First, the optical member 10 that was cleaned by deionized water and alcohol was prepared and set at a substrate holder of a thin film deposition apparatus.

After the degree of vacuum of the thin film deposition apparatus became less than or equal to 2×10⁻⁴ Pa, sputtering was performed using a Ta target with an incident power of 3 kW while introducing argon gas at 40 sccm and oxygen gas at 180 sccm to form the high refractive index layer 21a with a thickness of 14 nm and refraction index (n) of 2.20 on the optical member 10. Next, sputtering was performed using a Si target with an incident power of 6 kW while introducing argon gas at 30 sccm and oxygen gas at 180 sccm to form the low refractive index layer 22a with a thickness of 33 nm and refraction index (n) of 1.48

Thereafter, the high refractive index layer 21b with a thickness of 121 nm was formed on the low refractive index layer 22a by using the same material and by the same manufacturing method as the above described high refractive index layer 21a. Further, the low refractive index layer 22b with a thickness of 71 nm was formed on the high refractive index layer 21b by using the same material and by the same manufacturing method as the above described low refractive index layer 22a.

Next, sputtering was performed using a Zr containing Si target with an incident power 6 kW while introducing argon gas at 80 sccm and oxygen gas at 140 sccm to form the surface protection layer 32 with a thickness of 10 nm and refraction index (n) of 1.7 on the low refractive index layer 22b.

### Example 10

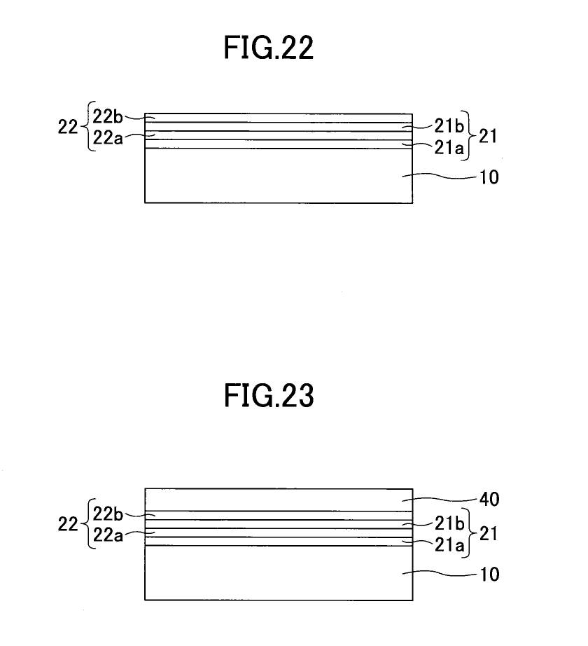

Example 10 of the embodiment is explained. FIG. 22 illustrates a structure of the optical element of example 10. The optical element of example 10 had a structure in which the high refractive index layers 21 (21a, 21b) and the low refractive index layers 22 (22a, 22b) were alternately stacked on the optical member 10. Here, the low refractive index layer 22b was made the same as the surface protection layer made of a mixed oxide of Si and Al, and the surface protection layer was omitted.

First, the optical member 10 that was cleaned by deionized water and alcohol was prepared and set at a substrate holder of a thin film deposition apparatus.

After the degree of vacuum of the thin film deposition apparatus became less than or equal to 2×10⁻⁴ Pa, sputtering was performed using a Si target with an incident power of 6 kW while introducing argon gas at 85 sccm and nitrogen gas at 105 sccm to form the high refractive index layer 21a with a thickness of 15 nm and refraction index (n) of 2.06 on the optical member 10. Next, sputtering was performed using an Al target and a Si target with incident powers of 2.5 kW and 6 kW, respectively, while introducing argon gas at 80 sccm and oxygen gas at 140 sccm to form the low refractive index layer 22a with a thickness of 35 nm and refraction index (n) of 1.49 on the high refractive index layer 21a.

Thereafter, the high refractive index layer 21b with a thickness of 136 nm was formed on the low refractive index layer 22a by using the same material and by the same manufacturing method as the above described high refractive index layer 21a. Further, the low refractive index layer 22b with a thickness of 90 nm was formed on the high refractive index layer 21b by using the same material and by the same manufacturing method as the above described low refractive index layer 22a.

Although sputtering was performed using the Al target and the Si target to form the low refractive index layer in example 10, sputtering may be performed by using an Al containing Si target.

### Example 11

Example 11 of the embodiment is explained. FIG. 23 illustrates a structure of the optical element of example 11. The optical element of example 11 had a structure in which the high refractive index layers 21 (21a, 21b) and the low refractive index layers 22 (22a, 22b) were alternately stacked on the optical member 10, further, the antifouling coating layer 40 was formed.

First, the optical member 10 that was cleaned by deionized water and alcohol was prepared and set at a substrate holder of a thin film deposition apparatus.

After the degree of vacuum of the thin film deposition apparatus became less than or equal to 2×10⁻⁴ Pa, sputtering was performed using a Si target with an incident power of 6 kW while introducing argon gas at 85 sccm and nitrogen gas at 105 sccm to form the high refractive index layer 21a with a thickness of 14 nm and refraction index (n) of 2.06 on the optical member 10. Next, sputtering was performed using an Al target and a Si target with incident powers of 2.5 kW and 6 kW, respectively, while introducing argon gas at 80 sccm and oxygen gas at 140 sccm to form the low refractive index layer 22a with a thickness of 34 nm and refraction index (n) of 1.49 on the high refractive index layer 21a.

Thereafter, the high refractive index layer 21b with a thickness of 135 nm was formed on the low refractive index layer 22a by using the same material and by the same manufacturing method as the above described high refractive index layer 21a. Further, the low refractive index layer 22b with a thickness of 86 nm was formed on the high refractive index layer 21b by using the same material and by the same manufacturing method as the above described low refractive index layer 22a.

Next, the antifouling coating layer 40 with a thickness of 7 nm was formed on the low refractive index layer 22b using a fluorine containing organic compound illustrated in Chemical formula 2.

Although sputtering was performed using the Al target and the Si target to form the low refractive index layer in example 11, sputtering may be performed by using an Al containing Si target.

### Example 12

Example 12 of the embodiment is explained. The optical element of example 12 has the structure same as that of example 11. The layers of example 12 were formed by methods same as those of example 11 except that the optical member 10 was made of sapphire and the thickness of each of the layers was as follows. The thickness of the high refractive index layer 21a was 17 nm, the thickness of the low refractive index layer 22a was 21 nm, the thickness of the high refractive index layer 21b was 134 nm, the thickness of the low refractive index layer 22b was 82 nm and the thickness of the antifouling coating layer 40 was 7 nm.

### (Test Results of Example 1 to Example 12)

Tables 2 to 4 illustrate a structure of layers, a value of the coefficient of dynamic friction, an ink eraser test result and rubbing test results of each of the optical elements of example 1 to example 12. The coefficient of dynamic friction was measured using HEIDON-18L manufactured by Shinto Scientific Co., Ltd. under a condition of moving speed: 150 mm/min, load: 50 g, and indenter: SUS 6 mm ball. The ink eraser test was performed using a surface test apparatus IMC-1550 in which an ink eraser (KOKUYO 512) was set at a front end portion under a condition in which the moving speed control of the substrate was 30, the number of times of reciprocation of the substrate was 50, load was 100 g, and the stroke was 6 cm. The durability to rubbing by an ink eraser was evaluated based on a difference in haze ratios before and after the rubbing that indicates degree of scattering of light due to cracks generated by the rubbing. Further, the rubbing test A was performed using a cotton material for 10 times of rubbing, and thereafter, an outside appearance was confirmed by view. The rubbing test B was performed using a steel wool material for 50 times of rubbing, and thereafter, an outside appearance was confirmed by view. The rubbing test C was performed using a steel wool material for 6000 times of rubbing, and thereafter, an outside appearance was confirmed by view. In each of the rubbing tests A, B and C, when cracks were not observed on the outside appearance, the result is expressed as “GOOD” and when cracks were observed on the outside appearance, the result is expressed as “BAD”. Further, blanks indicate that the test were not performed.

TABLE 2

| | | EXAM- | EXAM- | EXAM- | EXAM- |
|---|---|---|---|---|---|
| | | PLE 1 | PLE 2 | PLE 3 | PLE 4 |
| BASE MATERIAL | | CHEMICALLY STRENGTHENED GLASS | | | |
| MATE- | 1st layer | Ta₂O₅ | Ta₂O₅ | Si₃N₄ | Al₂O₃ |
| RIAL | 2nd layer | SiO₂ | SiO₂ | SnO₂/ | ZrO₂ |
| | | | | SiO₂ | |
| | 3rd layer | Ta₂O₅ | Ta₂O₅ | Si₃N₄ | MgF₂ |
| | 4th layer | SiO₂ | SiO₂ | SnO₂/ | — |
| | | | | SiO₂ | |
| | 5th layer | SnO₂/ | SnO₂/ | AFP | — |
| | | SiO₂ | SiO₂ | MATE- | |
| | | | | RIAL | |
| | 6th layer | — | AFP | — | — |
| | | | MATERIAL | | |
| THICK- | 1st layer | 14 | 14 | 26 | 58 |
| NESS | 2nd layer | 34 | 34 | 30 | 127 |
| (nm) | 3rd layer | 122 | 121 | 50 | 89 |
| | 4th layer | 68 | 71 | 88 | — |
| | 5th layer | 10 | 10 | 7 | — |
| | 6th layer | — | 7 | — | — |

| | | | | |
|---|---|---|---|---|
| COEFFICIENT OF | 0.26 | 0.11 | 0.16 | 0.48 |
| DYNAMIC FRICTION | | | | |
| HAZE RATIO (%) | 0.02 | | | |
| BEFORE INK | | | | |
| ERASER TEST | | | | |
| HAZE RATIO (%) | 0.52 | | | |
| AFTER INK | | | | |
| ERASER TEST | | | | |
| RUBBING TEST A | GOOD | GOOD | GOOD | BAD |
| RUBBING TEST B | BAD | GOOD | GOOD | BAD |
| RUBBING TEST C | | BAD | GOOD | |

TABLE 3

| | | EXAM- | EXAM- | EXAM- | EXAM- |
|---|---|---|---|---|---|
| | | PLE 5 | PLE 6 | PLE 7 | PLE 8 |
| BASE MATERIAL | | CHEMICALLY STRENGTHENED GLASS | | | |
| MATERIAL | 1st layer | Ta₂O₅ | Si₃N₄ | Ta₂O₅ | Ta₂O₅ |
| | 2nd layer | SiO₂ | SnO₂/ | SiO₂ | SiO₂ |
| | | | SiO₂ | | |
| | 3rd layer | Ta₂O₅ | Si₃N₄ | Ta₂O₅ | Ta₂O₅ |
| | 4th layer | SiO₂ | SnO₂/ | SiO₂ | SiO₂ |
| | | | SiO₂ | | |
| | 5th layer | SnO₂/ | DLC | — | AFP |
| | | SiO₂ | | | MATE- |
| | | | | | RIAL |
| | 6th layer | DLC | — | — | — |
| THICKNESS | 1st layer | 14 | 26 | 14 | 14 |
| (nm) | 2nd layer | 34 | 30 | 33 | 33 |
| | 3rd layer | 121 | 50 | 121 | 121 |
| | 4th layer | 71 | 88 | 81 | 81 |
| | 5th layer | 10 | 3 | — | 7 |
| | 6th layer | 3 | — | — | — |

| | | | | |
|---|---|---|---|---|
| COEFFICIENT OF | 0.24 | 0.22 | 0.35 | 0.11 |
| DYNAMIC FRICTION | | | | |
| HAZE RATIO (%) | | | 0.02 | |
| BEFORE INK | | | | |
| ERASER TEST | | | | |
| HAZE RATIO (%) | | | 1.12 | |
| AFTER INK | | | | |
| ERASER TEST | | | | |
| RUBBING TEST A | GOOD | GOOD | GOOD | GOOD |
| RUBBING TEST B | GOOD | GOOD | BAD | GOOD |
| RUBBING TEST C | | | | BAD |

TABLE 4

| | | EXAM- | EXAM- | EXAM- | |
|---|---|---|---|---|---|
| | | PLE 9 | PLE 10 | PLE 11 | EXAM- |
| | | CHEMICALLY STRENGTHENED | | | PLE 12 |
| BASE MATERIAL | | GLASS | | | SAPPHIRE |
| MATE- | 1st layer | Ta₂O₅ | Si₃N₄ | Si₃N₄ | Si₃N₄ |
| RIAL | 2nd layer | SiO₂ | Al₂O₃/ | Al₂O₃/ | Al₂O₃/ |
| | | | SiO₂ | SiO₂ | SiO₂ |
| | 3rd layer | Ta₂O₅ | Si₃N₄ | Si₃N₄ | Si₃N₄ |
| | 4th layer | SiO₂ | Al₂O₃/ | Al₂O₃/ | Al₂O₃/ |
| | | | SiO₂ | SiO₂ | SiO₂ |
| | 5th layer | ZrO₂/ | — | AFP | AFP |
| | | SiO₂ | | MATE- | MATE- |
| | | | | RIAL | RIAL |
| | 6th layer | — | — | — | — |
| THICK- | 1st layer | 14 | 15 | 14 | 17 |
| NESS | 2nd layer | 33 | 35 | 34 | 21 |
| (nm) | 3rd layer | 121 | 136 | 135 | 134 |
| | 4th layer | 71 | 90 | 86 | 82 |
| | 5th layer | 10 | — | 7 | 7 |
| | 6th layer | — | — | — | — |

| | | | | |
|---|---|---|---|---|
| COEFFICIENT OF | 0.3 | 0.16 | 0.09 | 0.11 |
| DYNAMIC FRICTION | | | | |
| HAZE RATIO (%) | 0.03 | | | |
| BEFORE INK | | | | |
| ERASER TEST | | | | |
| HAZE RATIO (%) | 0.59 | | | |
| AFTER INK | | | | |
| ERASER TEST | | | | |
| RUBBING TEST A | | GOOD | GOOD | GOOD |
| RUBBING TEST B | | BAD | GOOD | GOOD |
| RUBBING TEST C | | | GOOD | GOOD |

As the result of the ink eraser test, the difference in haze ratios before and after the test of the optical element of example 7 was apparently larger than those of the optical elements of example 1 and example 9. This is considered that by forming mixed oxide of Si and Sn or mixed oxide of Zr and Si as the outermost layer, cracks were hardly generated.

As the result of the measurement of the coefficient of dynamic friction, it was 0.35 for the optical element of example 7, while it was 0.26 for the optical element of example 1 in which mixed oxide of Si and Sn was formed as the outermost layer, it was 0.3 for the optical element of example 9 in which mixed oxide of Zr and Si was formed as the outermost layer and it was 0.16 for the optical element of example 10 in which mixed oxide of Si and Al was formed as the outermost layer. Thus, it was confirmed that the coefficient of dynamic friction was lowered.

As the result of the rubbing test A, cracks were observed in the optical element of example 4 whose coefficient of dynamic friction was 0.48. As the result of the rubbing test B, cracks were observed in the optical element of example 1 whose coefficient of dynamic friction was 0.26, the optical element of example 4 whose coefficient of dynamic friction was 0.48, the optical element of example 7 whose coefficient of dynamic friction was 0.35 and the optical element of example 10 whose coefficient of dynamic friction was 0.16. As the result of the rubbing test C, although cracks were observed in the optical element of example 2 and the optical element of example 8, cracks were not observed in the optical elements of example 3, example 11 and example 12 each of which uses Si₃N₄ whose stiffness constant C33 was 30.4×10¹⁰ N/m².

Although a preferred embodiment of the optical element has been specifically illustrated and described, it is to be understood that minor modifications may be made therein without departing from the spirit and scope of the invention as defined by the claims.

The present invention is not limited to the specifically disclosed embodiments, and numerous variations and modifications may be made without departing from the spirit and scope of the present invention.

What is claimed is:

1. An optical element comprising:
an optical member made of a material that transmits light;
a high refractive index layer and a low refractive index layer that are stacked on a front surface of the optical member; and
a surface protection layer that is formed on an upper most layer among the high refractive index layer and the low refractive index layer,
the surface protection layer being made of a material including one of a mixed oxide of Si and Sn, a mixed oxide of Si and Zr, and a mixed oxide of Si and Al, and
the refraction index of the surface protection layer being less than or equal to the refraction index of the high refractive index layer and greater than or equal to the refraction index of the low refractive index layer.

2. The optical element according to claim 1,
wherein the refraction index of the surface protection layer is greater than or equal to 1.48 and less than or equal to 1.9.

3. The optical element according to claim 1,
wherein the thickness dₛ of the surface protection layer is greater than or equal to 1 nm, and satisfies Equation 1, where the refraction index of the high refractive index layer is Nₕ and the refraction index of the surface protection layer is Nₛ.
$${d}_{s} ≦ 650 \times exp \{ \frac{- 14 \times ( {N}_{s} - 1.43 )}{( {N}_{h} - {N}_{s} )} \} + 50 \times ( {N}_{h} - {N}_{s} ) \qquad [ Equation 1 ]$$

4. The optical element according to claim 1,
wherein the thickness dₛ of the surface protection layer is greater than or equal to 1 nm, and satisfies Equation 2, where the refraction index of the high refractive index layer is Nₕ and the refraction index of the surface protection layer is Nₛ.
$${d}_{s} ≦ 700 \times exp \{ \frac{- 18 \times ( {N}_{s} - 1.44 )}{( {N}_{h} - {N}_{s} )} \} + 45 \times ( {N}_{h} - {N}_{s} ) \qquad [ Equation 2 ]$$

5. The optical element according to claim 1,
wherein the high refractive index layer, the low refractive index layer and the surface protection layer are amorphous.

6. The optical element according to claim 1,
wherein stiffness constant C33 of one or more layer of the high refractive index layer, the low refractive index layer and the surface protection layer is greater than or equal to 7×10¹⁰ N/m².

7. The optical element according to claim 1,
wherein one or more layer of the high refractive index layer is one of ZrO₂, TiO₂, Si₃N₄ and Al₂O₃.

8. The optical element according to claim 1, further comprising:
an antifouling coating layer made of an organic material formed on the surface protection layer.

9. The optical element according to claim 1,
wherein the low refractive index layer is made of a material whose refraction index is less than or equal to 1.5, and
wherein the high refractive index layer is made of a material whose refraction index is greater than or equal to 2.0.

10. The optical element according to claim 1,
wherein the optical member is a lens.

11. The optical element according to claim 1,
wherein the optical member is a chemically strengthened glass including, in terms of an oxide, 62 to 68 mol % of SiO₂, 6 to 12 mol % of Al₂O₃, 7 to 13 mol % of MgO, 9 to 17 mol % of Na₂O and 0 to 7 mol % of K₂O, wherein a difference obtained by subtracting the containing amount of Al₂O₃ from the total containing amount of Na₂O and K₂O is less than 10 mol % and the containing amount of ZrO₂, if included, is less than or equal to 0.8 mol %.

12. The optical element according to claim 1,
wherein the optical member is an alkali aluminosilicate glass and a chemically strengthened glass made of a composition of, in terms of an oxide, 60 to 70 mol % of SiO₂, 6 to 14 mol % of Al₂O₃, 0 to 15 mol % of B₂O₃, 0 to 15 mol % of Li₂O, 0 to 20 mol % of Na₂O, 0 to 10 mol % of K₂O, 0 to 8 mol % of MgO, 0 to 10 mol % of CaO, 0 to 5 mol % of ZrO₂, 0 to 1 mol % of SnO₂, 0 to 1 mol % of CeO₂, less than 50 ppm of As₂O₃ and less than 50 ppm of Sb₂O₃, wherein 12 mol %≦Li₂O+Na₂O+K₂O 20 mol % and 0 mol %≦MgO+CaO≦10 mol %.

13. The optical element according to claim 1,
wherein the optical member is a chemically strengthened glass including, in terms of an oxide, 63.0 to 67.5 mol % of SiO₂, 9.5 to 12.0 mol % of Al₂O₃, 8.5 to 15.5 mol % of Na₂O, 2.5 to 4.0 mol % of K₂O, 3.0 to 9.0 mol % of MgO, 0 to 2.5 mol % of Σ(CaO+SrO+BaO+ZnO), 0.5 to 1.5 mol % of TiO₂, 0.02 to 0.5 mol % of CeO₂, 0 to 0.35 mol % of As₂O₃, 0 to 1.0 mol % of SnO₂ and 0.05 to 2.6 mol % of F₂, wherein SiO₂/Al₂O₃ is 5.3 to 6.85, Na₂O/K₂O is 3.0 to 5.6, Al₂O₃/K₂O is 2.8 to 3.6 and Al₂O₃/(TiO₂+CeO₂) is 7.6 to 18.5.

14. The optical element according to claim 1,
wherein the optical member is made of sapphire.

15. An optical element comprising:
an optical member made of a material that transmits light;
a high refractive index layer and a low refractive index layer that are stacked on a front surface of the optical member; and
an antifouling coating layer formed on an uppermost layer among the high refractive index layer and the low refractive index layer.
